(19) United States
(12) Patent Application Publication
(10) Pub. No.: US 2003/0035864 A1
(43) Pub. Date: Feb. 20, 2003

(54) Dehydratable pasta product having a sauce-like filling

(76) Inventors: Robert Meschewski, Crystal Lake, IL (US); John D. Koury, Tracy, CA (US)

Correspondence Address: Micheal D. Lake, Esq., Wallenstein & Wagner, Ltd., 53rd Floor, 311 South Wacker Drive, Chicago, IL, 60606-6630, US

(21) Appl. No.: 10/252,463

(22) Filed: Sep. 23, 2002

Related U.S. Application Data
(63) Continuation of application No. 09/714,801, filed on Nov. 15, 2000, now abandoned.

(51) Int. Cl. A23G 3/00

(52) U.S. Cl. 426/94

(57) ABSTRACT

According to one aspect of the invention, a pasta product having a pocket is provided with a filling which has a sauce-like consistency when in a hydrated state. According to another aspect of the invention, both the pasta body and the filling have a composition which permits them to be dehydrated to a moisture level sufficient to be packaged, shipped, and stored, as a dry good without the need for pasteurization, while permitting rehydration upon cooking to an extent that the pasta body achieves a desired supple texture and the filling achieves a sauce-like texture. The filling of the present invention is capable of dehydration to shelf-stable moisture levels while maintaining rehydratability to a sauce-like consistency and texture.

### TECHNICAL FIELD

The present invention relates to comestible carbohydrates in the form of a cooked dough pasta product having a filling, and more particularly to such a pasta product having a filling that is capable of dehydration to moisture levels that allow for shelf-stability while maintaining properties that allow for rehydration to a sauce-like texture.

### BACKGROUND OF THE INVENTION

Pasta dishes with sauces, such as tomato based sauces, are a traditional favorite and continue to enjoy immense popularity. Accordingly, there has been, and continues to be, a robust market for partially and completely pre-prepared pasta dishes that are shelf stable. Shelf stability requires that certain types of microorganisms capable of spoiling the pasta product under normal storage conditions are maintained below accepted levels.

An example of a completely pre-prepared pasta dish is a completely precooked pasta premixed with a sauce. Sauces for such a fully pre-prepared dish may include tomato-based sauces, cheese-based sauces, cream-based sauces, or oil-based sauces (e.g. olive oil). A problem with these fully pre-prepared dishes is that they must be either canned and pasteurized, or frozen, to ensure shelf stability. Both of these methods add significant cost to packaging, shipping, storage, and handling of the product. Also, pasta canned with sauce can result in over-hydrated pasta, i.e., the pasta can lose its desired texture and become too soggy.

An example of a partially pre-prepared dish is where the pasta and sauce are individually packaged, and can be sold separately. The sauce can be added to any pasta that the consumer prepares from a dried pasta. This partially pre-prepared dish has the advantage that at least the dehydrated pasta portion can be packaged, shipped, and stored at relatively lower cost and convenience. However, the sauce still suffers from the disadvantage of relatively higher costs and inconvenience as it must be either frozen or canned, typically canned.

There are pre-packaged dishes where both the pasta and the sauce (typically cheese) are individually packaged within a unitary package or kit. The most common of these is maccaroni and cheese. In many of these kit-type packages, both the cheese and the pasta are dehydrated. Hence, these kits provide economy and convenience in packaging, shipping, handling, and storage. Some kits offer individually packaged cheese sauce in a hydrated form. All of these types of kits, however, suffer the inconveniences and added costs of: individual packaging within the kit; mixing by the consumer; and for the dehydrated sauce (cheese) kits, the need for added ingredients (such as milk and/or butter) to achieve the proper texture and flavor of the sauce.

There are also stuffed or filled pasta products on the market that contain various solid or semi-solid fillings including meat, meat by products, animal fats, cheese, vegetables, or the like. Some stuffed or filled pasta products have been developed as dehydrated products that exhibit shelf-stable qualities. However, these presently-known shelf-stable or dried-filled pasta products require dehydration below a very low moisture content (along with either sterilization or heat processing, or both, such as pasteurization or retorting) to ensure shelf stability.

A presently known dried filled pasta product that does not require pasteurization or retorting is commonly referred to as “super-dried” pasta. This type of pasta results from a process that dries the filled pasta to water levels below 10-12%, to a point which is much drier than other conventional pasta. However, one of the main drawbacks to “super-dried” pasta is that it requires special packaging to prevent rehydration and/or oxygenation by ambient conditions during normal shelf storage. Therefore, “super-dried” filled pastas cannot be stored in standard dry pasta packaging. Thus, these types of pastas also suffer the disadvantage of higher packaging costs.

Another major problem associated with dehydrated filled pasta products, is maintaining proper texture of the pasta and filling upon rehydration. The presently known dried filled pasta products are filled with meat or cheese-based fillings. When these types of pasta products are initially dehydrated, they retain a residual fat content from the meat or cheese that acts as a plasticizer. Upon rehydration, these pastas exhibit a combination moisture and fat texture that is typically not appealing to the consumer.

Finally, none of the presently known dried filled pasta products provide a convenient combination of a pasta and a rehydratable filling having a sauce-like texture, such as tomato sauce, in a single product that does not require special packaging or sterilization steps during production.

Thus, there is a need for a shelf-stable dehydrated pasta product having a sauce-like filling upon rehydration. There is a need for a filled dried pasta that does not require sterilization or super drying to ensure shelf stability so that it can be packaged by standard dried pasta methods.

The present invention provides such pasta products, while making other advancements in the art which will become apparent upon reading the specification and claims.

### SUMMARY OF THE INVENTION

According to one aspect of the invention, a pasta product having a pasta body with a pocket is provided. The pocket contains a filling having a sauce-like consistency when in a re-hydrated state. According to another aspect of the invention, a pasta with filling can be provided as a dehydrated product which can be packaged, shipped, and stored, in the same cost and convenience effective manners as conventional dried pasta alone. According to another aspect of the invention, a shelf-stable pasta product and its filling have a moisture content that is typical of conventional dried pasta. A filling of the present invention is dehydratable to a moisture content that allows shelf stability while being rehydratable to an acceptable sauce-like consistency and texture. Thus, a dehydrated pasta product of the present invention does not require sterilization through pasteurization or other processing. Upon cooking in water, sauce re-hydrates along with the pasta at acceptably similar rates.

It is contemplated that certain fillings according to the present invention may comprise any type of filling that, when dehydrated to the levels of a normal pasta, is not supportive of significant microorganism growth. It is also contemplated that suitable fillings will not exhibit degradation of texture after rehydration. Exemplary sauce-like fillings of the present invention include one or more pretreated carbohydrates, such as bread crumbs, which permits the carbohydrate to undergo primarily only rehydration upon subsequent exposure to water and/or heat, thereby ensuring a sauce-like texture of the filling while allowing the filling to be shelf stabile when dehydrated to a moisture content that is within an acceptable range for conventional dried pasta. The pretreatment of the carbohydrate may include adding water, cooking, and/or disintegration or pulverizing a solid carbohydrate.

### DETAILED DESCRIPTION OF THE PREFERRED EMBODIMENT

While the present invention will be described fully hereinafter with reference to the accompanying drawings, in which a particular embodiment or embodiments are disclosed, it is to be understood at the outset that persons skilled in the art may modify the specific embodiments herein described while still achieving the desired result of this invention. Accordingly, the description which follows is to be understood as a disclosure of exemplary embodiments directed to persons skilled in the appropriate art and not as limitations of the present invention.

The pasta product of the present invention is made by initially preparing a raw pasta dough. This may be done by preparing a mix comprising a ground cereal grain product and water. It is preferable, for example, to use flour and/or semolina obtained by grinding grains, such as hard wheat, soft wheat, rice, corn, or the like. Additives, such as fresh, frozen or dehydrated eggs, salt, spices, seasoning, emulsifiers and/or natural coloring matter, such as tomato or spinach, may be added to the ground product. The mixture may be kneaded to give it a pasty homogeneous texture.

A parent sheet of pasta may then be formed, for example by extrusion and/or rolling. This may be done in particular by forming a strand of pasta by extrusion and then rolling the strand between several successive pairs of rollers until a parent sheet has a desired thickness. This parent sheet may then be cut into leaves of predetermined shape for preparing the pasta envelopes mentioned. For example, the parent sheet may be cut into rectangular leaves which are then folded to form pasta envelopes in the shape of squares. The parent sheet may also be cut up into circular leaves which are then folded to form pasta envelopes in the shape of crescents. However, any preform shape may be cut from the parent sheet in order to facilitate the formation of the desired finished pasta shape. A particularly preferred pasta is an egg-based pasta which is mixed, kneaded, sheeted, cut and formed to either a classic tortellini or mezzaluna shape.

A rehydratable filling according to the invention has been developed to provide the benefits of the invention described above and to provide a pizza sauce flavor and texture. The filling includes: Ricotta and Parmesan cheeses from cow's milk, which include cheese culture, salt, and enzymes; Romano cheese from sheep's milk, including cheese cultures, salt, and enzymes; tomato powder; breadcrumbs from wheat flour with salt; margarine from soybean oil including salt; ascorbic acid and citric acid; and, pizza flavor from chili powder, oregano, onion, pepper, paprika, garlic, nutmeg, sage, and basil.

The filling is preferably dehydrated and pelletized. One or more pellets (as desired) are placed on a pasta leaf by a depositor or other placing mechanism. However, the filling may also be deposited in a liquid, semi-liquid or paste-like form and then dehydrated along with the pasta leaf at a later step. The pasta is then formed around the filling, shape-formed (e.g. to a tortellini or mezzaluna shape) and sealed, thereby creating a pasta shape having a pocket containing the filling. The pasta may be formed by folding, molding, or other forming techniques. Some pasta products may also be crimped in order to seal the filling within the pasta shape. The filled pasta product is then dried to a moisture content of about 10-12% moisture by weight and a water activity of <0.65, preferably around 0.50. This enables stability and commercial sterility for handling and storage while permitting proper rehydration.

According to the invention, the pizza-flavored sauce is comprised of prominent constituents which permit the overall filling to behave more like pasta in terms of microorganism activity at the dried moisture content than would conventional fillings such as those which have prominent meat and/or cheese constituents. Hence, the filled pasta can have significant shelf life at the dried moisture contents disclosed herein. In a preferred embodiment, these prominent constituents are bread crumbs and tomato powder which total 38%-41.5% by weight of the total weight of the sauce. These constituents behave more akin to the starches constituting the pasta than will the protein, amino acid, and enzyme-rich meat and cheese filings conventionally used as fillings. So too, these constituents behave more like the pasta starches in a rehydration process than will fillings having significant amounts of meat or cheeses.

The use of bread crumbs is exemplary on this point because, like the pasta itself, it constitutes a pre-cooked cereal grain starch. Being precooked, the starches in the bread will merely rehydrate upon cooking by the consumer. This prevents the filling from lumping into a cooked semi-solid. The bread is also crumbed to physically dissociate the cooked starch mass to further avoid a lumping of the filling. In the meantime, the crumbs add wetness to the sauce upon rehydration while adding body to the sauce in their swelled form.

Hence, it is contemplated that sauces/fillings according to the invention may be provided by addition of one or more pre-treated starches, such as bread crumbs, as a significant constituent which upon subsequent cooking by the consumer, will primarily undergo only rehydration and will assist the filling to be shelf-stable when dehydrated to a moisture content that is in an acceptable range for conventional dried pasta.

Likewise, the tomato powder is lacking the animal protein mass associated with conventional meat and cheese fillings while at the same time providing constituents very amenable to rehydration, such as sugars, salts, and starches. These constituents are important because they help suppress the water activity level.

The cheeses added to the pizza-flavored sauce do not appear to present a problem with either microbial activity (in the dehydrated state) or rehydration because the water activity level of the whole mixture is controlled.

In the preferred embodiment, soy bean oil is provided at 16-18% by weight of the mixture. The soybean oil acts as a plasticizing agent to keep the product soft without relying upon moisture.

It is also contemplated that other hydrophillic and/or water soluble constituents may be beneficial to providing a shelf-stable relatively easily rehydratable sauce-like filling. For example, the pizza-flavored sauce disclosed herein includes salt which may be introduced directly or indirectly through addition of other salt-containing constituents, for example: the Ricotta, Parmesan and Romano cheeses; the margarine; and the breadcrumbs. The powdered forms of certain spices such as chili powder, oregano, onion, pepper, paprika, garlic, nutmeg, sage, and basil add flavoring tissue to the filling are compatible with desired drying.

As used herein, “sauce” or “sauce-like texture” are intended to distinguish from conventional pasta fillings having either a chunky or paste-like texture such as meat and/or cheese filled pastas, for example conventional ravioli.

Providing a pasta with an internally disposed sauce provides numerous advantages. For example, since the sauce is not released until the pasta is chewed, a unique taste and eating sensation is produced. Also, spillage of sauce on clothing, table surfaces, or the like, is reduced. Since the sauce is internal to the pasta: (1) cookware used to prepare the pasta is reduced to a single container as the sauce is cooked within the pasta; and, (2) the container used is more easily cleaned as the sauce does not have contact with the container surfaces.

While the specific embodiments have been illustrated and described, numerous modifications come to mind without significantly departing from the spirit of the invention and the scope of protection is only limited by the scope of the accompanying claims.

What is claimed is:

1. A pasta product comprising:
a pasta body having a pocket; and,
a filling in the pocket of the pasta body, the filling having a sauce-like consistency.

2. The pasta product of claim 1, wherein both the pasta body and the filling having a composition permitting them to be dehydrated to a moisture level sufficient to be packaged, shipped, and stored as a dry good, while permitting rehydration of the pasta body to a desired supple texture and permitting rehydration of the filling to have a sauce-like texture.

3. The pasta product of claim 2, wherein the pasta product in a dried state has a moisture content of less than about 10-12% by weight and a water activity level of less than about 0.65.

4. The pasta product of claim 2, wherein the pasta body and the filling have a water activity level between about 0.50 and 0.65.

5. The pasta product of claim 2, wherein the pasta body and the filling have a water activity level of about 0.50.

6. The pasta product of claim 1, wherein the filling includes 26-29% cheese by weight, 18-20% bread crumbs by weight, 20-21.5% tomato powder by weight, and 16-18% soy bean oil by weight.

7. A pasta product comprising:
a pasta body having a pocket; and
a filling in the pocket of the pasta body;
wherein both the pasta body and the filling have a composition permitting them to be dehydrated to a moisture level sufficient for shelf stability while packaged in conventional dried pasta packaging and without the need for further sterilization processing.

8. The pasta product of claim 7, wherein the composition further permits rehydration of the pasta body to a desired supple texture and rehydration of the filling to have a sauce-like texture.

9. The pasta product of claim 8, wherein the filling is a tomato-based filling.

10. The pasta product of claim 8, wherein the filling-has a pizza flavor

11. A pasta product comprising:
an outer pasta body; and
an inner filling within the outer pasta body;
wherein both the pasta body and the filling have a composition permitting them to be dehydrated to a moisture level sufficient for shelf stability while packaged in conventional dried pasta packaging and without the need for either one of pasteurization, blanching, and retorting; and
wherein the filling has a sauce-like texture upon rehydration of the pasta product.

12. A method of making a pasta having a filling comprising the steps of:
pretreating a carbohydrate in a manner which permits the carbohydrate to undergo primarily only rehydration upon subsequent exposure to water and/or heat, the carbohydrate being included in the filling;
forming a pasta leaf around the filling to form at least a partial pocket having the filling therein;
drying the pocket and filling to a moisture content of about 10-12% moisture by weight and a water activity of less than 0.65; and
packaging the pasta shape in conventional packaging for dried pasta.

13. The method according to claim 12, wherein the pretreating step includes mixing the carbohydrate with water and cooking to form a cooked product.

14. The method according to claim 13, wherein the pretreating step further includes dehydrating and disintegrating the cooked product.

15. The method according to claim 14, wherein the cooked product is bread.

16. The method according to claim 15, wherein the filling further includes tomato powder.

17. A method of making a pasta having a filling comprising the steps of:
pretreating a carbohydrate in a manner which permits the carbohydrate to have a sauce-like consistency upon rehydration from a dehydrated state;
adding the pre-treated carbohydrate to other constituents to form a filling; and,
locating the filling in a pasta pocket.

18. The method of claim 17 including the step of forming a pellet from the filling and drying the pellet before the locating step, the pellet being located in the pasta pocket.

19. The method of claim 17 including the step of drying the pocket and filling to a moisture content of about 10-12% moisture by weight and a water activity of less than 0.65.

20. The method of claim 18 including the step of drying the pocket and filling to a moisture content of about 10-12% moisture by weight and a water activity of less than 0.65.

21. The method of claim 17 including the step of packaging the pasta shape in conventional packaging for dried pasta.

22. The method of claim 18 including the step of packaging the pasta shape in conventional packaging for dried pasta.

23. The method of claim 19 including the step of packaging the pasta shape in conventional packaging for dried pasta.

24. The method of claim 20 including the step of packaging the pasta shape in conventional packaging for dried pasta.
